(19) United States
(12) Patent Application Publication
(10) Pub. No.: US 2017/0234060 A1
(43) Pub. Date: Aug. 17, 2017

(54) SILL WITH DETACHABLE WATER DRAINAGE TROUGH FOR HIGH DIFFERENTIAL PRESSURE PERFORMANCE

(71) Applicant: JELD-WEN, Inc., Klamath Falls, OR (US)

(72) Inventors: Chris F. Graetsch, Klamath Falls, OR (US); Christopher D. Edwards, Klamath Falls, OR (US); Arin A. Totten, Klamath Falls, OR (US); Derek L. Kindt, Klamath Falls, OR (US); David L. Yagla, Klamath Falls, OR (US)

(21) Appl. No.: 15/400,967

(22) Filed: Jan. 7, 2017

Related U.S. Application Data
(60) Provisional application No. 62/276,788, filed on Jan. 8, 2016.

(51) Int. Cl. E06B 7/14; E06B 1/22; E06B 3/42; E06B 1/36; E06B 1/70; E06B 1/52; E06B 1/18

(52) U.S. Cl. CPC E06B 7/14; E06B 1/52; E06B 1/22; E06B 1/18; E06B 1/36; E06B 1/702; E06B 3/42

(57) ABSTRACT

A sill assembly for a door or window frame includes an elongate sill body with a water catchment tray and one or more drainage passages extending from the catchment tray to an outlet, and a drainage trough mounted to an underside of the sill body and depending downwardly therefrom to define a reservoir that receives water that drains from the outlet of the drainage passages. The drainage trough includes weep holes which restrict outflow from the reservoir and is detachable from the sill body, which facilitates the manufacture of the sill assembly in different configurations to suit site requirements.

### RELATED APPLICATION

This application claims the benefit under 35 U.S.C. §119(e) from U.S. Provisional Patent Application No. 62/276,788, filed Jan. 8, 2016, which is incorporated herein by reference.

### TECHNICAL FIELD

This disclosure relates to sills for doors and windows, and, more particularly, to such sills with water drainage features for high differential-pressure (high DP) applications and to convertible sill assemblies.

### BACKGROUND

Door sills including water catchment and drainage features are known in the art for preventing water ingress in high differential pressure environments. Many such sills employ interior drainage channels and multiple chambers with drainage restrictions leading to an exterior weep. Some employ a column of standing water within the drainage pathway to resist water ingress from wind-driven rain and high differential pressures of the kind experienced in many coastal areas during tropical storms, typhoons, and hurricanes. In order to contain a column of water sufficient to resist differential pressures (DP) across the door of, for example, 35 or 50 psi, the sill must typically be relatively tall. Typically the height of such a high-DP sill at the threshold above the adjacent interior floor and exterior decking presents challenges for compliance with the American for Disabilities Act (ADA) or other handicap-accessibility or wheelchair-accessibility regulations, in that a tall threshold can impede entry and egress of persons with mobility impairment.

To ease ADA compliance, some known sills employ a low-profile design that forms a DP-resistant water column within a drain trough or chamber that depends downwardly from an outermost edge of the sill, below the level of the floor or subfloor on which the threshold portion of the sill structure is supported. Such a drainage trough forms an exterior chamber in the drainage pathway of the sill and is positioned outboard of the exterior edge of the floor or subfloor on which the sill is supported. Weep openings along the bottom of the drain trough are sized relatively small so that a column of water is retained within the trough during high DP conditions to thereby resist ingress of water upwardly into the sill and into the building via the door seal or track of the sill.

The present inventors have recognized certain disadvantages of low-profile sills with exterior drop-down drain troughs. For example, the downwardly depending trough, which can extend an inch or two below the bottom of the sill, requires clearance in the exterior decking or flooring to accommodate it. Not all installation locations allow for such clearance. The present inventors have therefore identified a need for improved door sills with water drainage features for high differential pressure environments.

### BRIEF DESCRIPTION OF THE DRAWINGS

FIG. 1 is an isometric view of a door frame and sill assembly according to a preferred embodiment.

FIG. 2 is an enlarged isometric view of the sill assembly of FIG. 1.

FIG. 3 is an isometric section view of the sill assembly of FIG. 2 with jamb members of the door frame omitted and showing detail of a removable drop-down drainage trough.

FIG. 4 is a bottom view of the sill assembly of FIG. 3 with the door frame and corner key components omitted, showing detail of drainage openings formed in interior walls of the sill body.

FIG. 5 is an isometric view of the sill assembly of FIG. 2 with door jamb and a left-side corner key omitted, and with the drop-down drainage trough/reservoir removed.

FIG. 6 is an end elevation view of the sill assembly of FIG. 2, with the jamb members and left corner key omitted to show detail of the sill body and right corner key.

FIG. 7 is an enlarged isometric detail view of a drainage trough of the sill assembly of FIGS. 1-4 and 6.

FIG. 8 is an isometric view of the right-side corner key of the sill assembly of FIGS. 5 and 6, marked to show the location of a score or cutting region along which an end cap for the drainage trough can be removed when necessary.

### DETAILED DESCRIPTION OF PREFERRED EMBODIMENTS

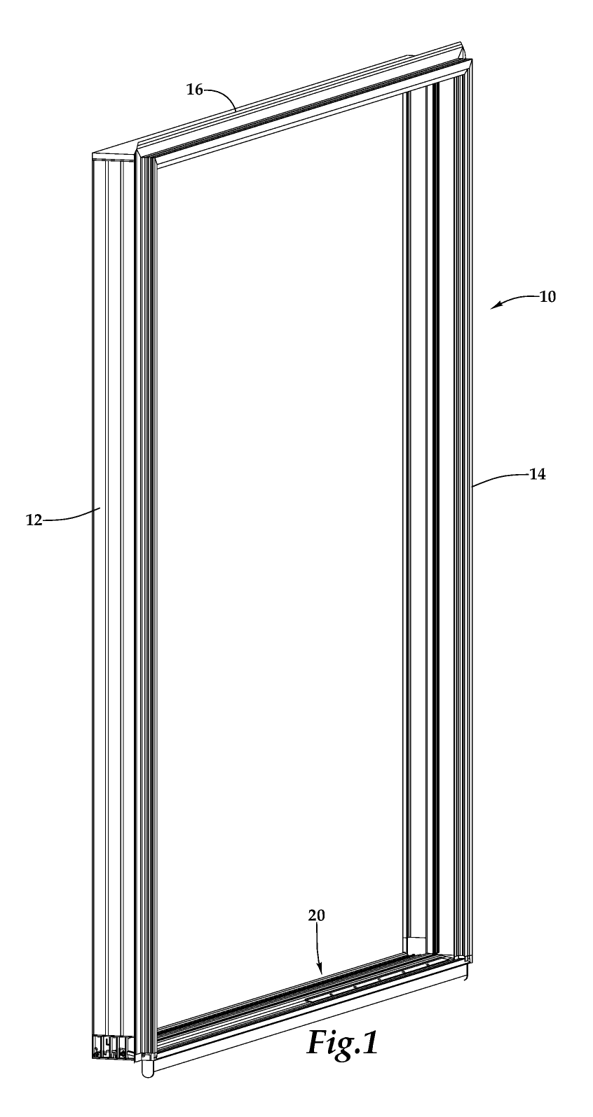

With reference to FIG. 1, a door frame 10 according to a preferred embodiment includes left and right jambs 12, 14, a head jamb 16, and a sill assembly 20. In combination, the side jambs 12, 14, head jamb 16 and sill assembly 20 are sized to retain one or more door panels (not shown). The embodiment of the frame 10 depicted herein is a frame for a sliding glass door or other sliding patio door. However, some embodiments of the inventions described herein may be used in frames and sill assemblies for non-sliding doors, such as conventionally side-hinged entry doors, or for windows or other fenestration systems not specifically illustrated herein. Consequently, nothing in the detailed description should be construed as limiting the invention to frames and sills for sliding doors.

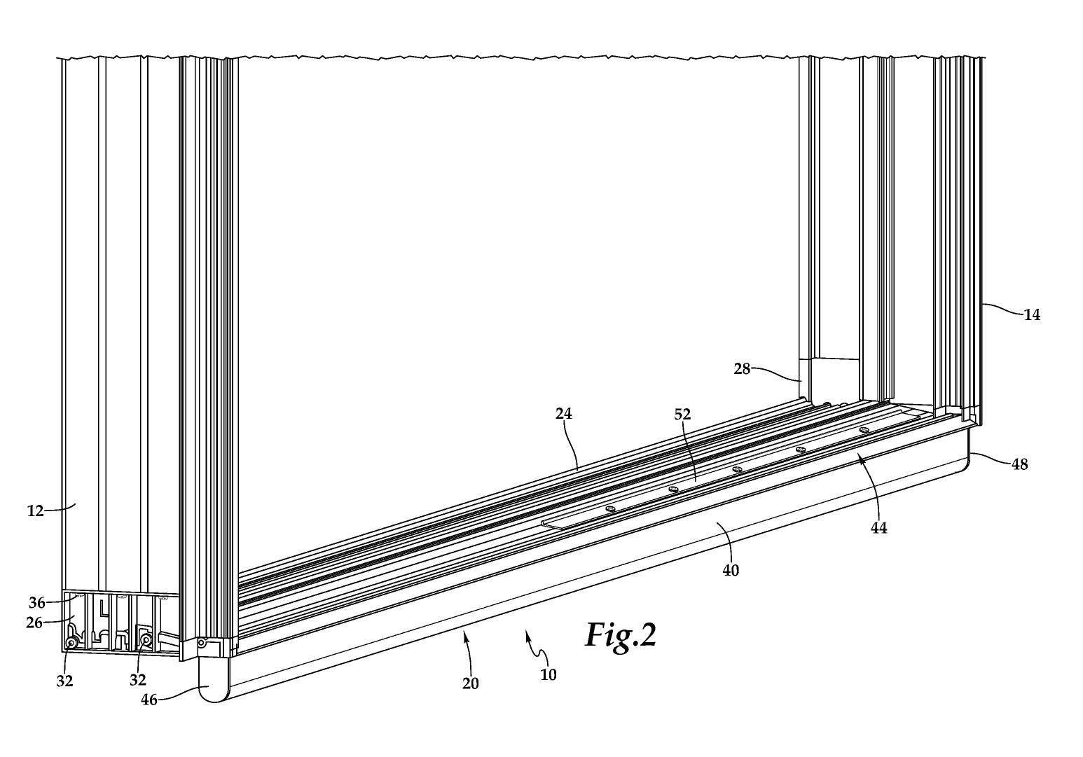

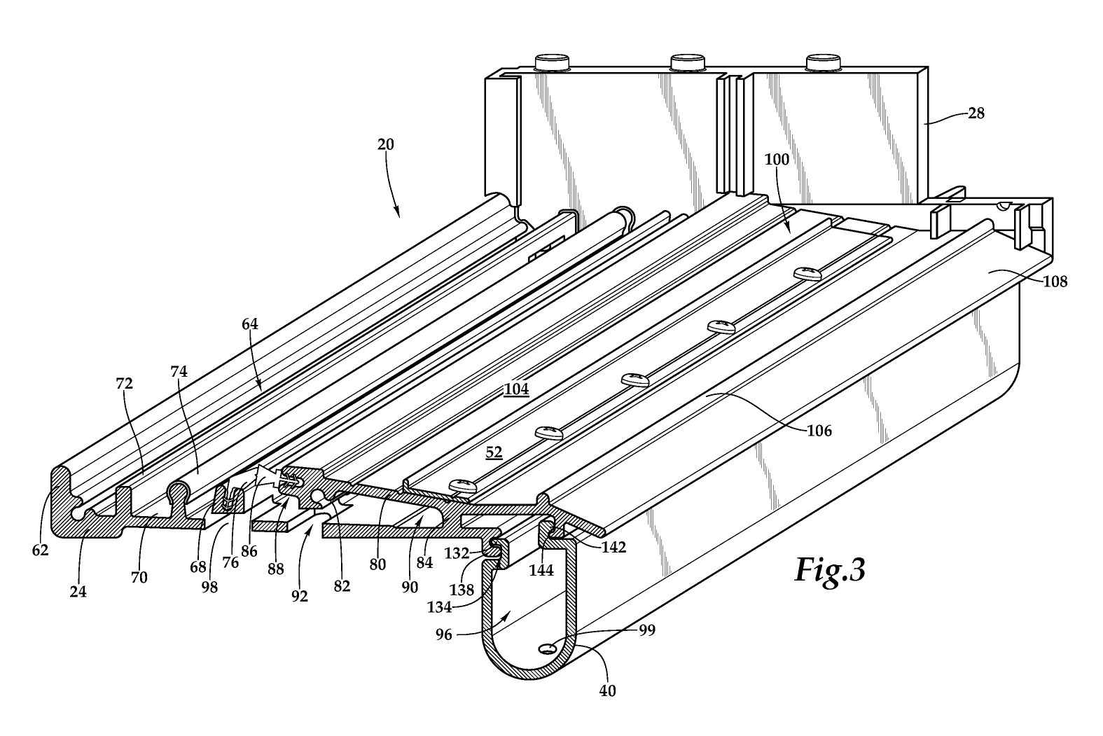

FIG. 2 is an enlarged view of door frame 10 showing detail of sill assembly 20. With reference to FIG. 2, sill assembly 20 includes a sill body 24 attached to left and right jambs 12, 14 via respective left and right corner keys 26, 28. Left and right corner keys 26, 28 are preferably made of molded plastic for rot resistance and affixed to opposite ends of sill body 24 by screws 32 and/or adhesive or other means. Similarly, corner keys 24 and 26 are fixed to left and right jambs 12 and 14 by screws 36 or other means, holding all or a portion of jambs 12, 14 above the surface of sill assembly 20. Sill assembly 20 includes a drainage trough 40 which depends downwardly from an exterior margin 44 of sill body 24 outside of the plane of the doors, as described below in greater detail with reference to FIGS. 3-7. End cap portions 46, 48 of corner keys 26, 28 are fitted against the ends of drainage trough 40 to form a container or reservoir within the trough as further described below. A tread bar 52 is fastened to a top surface 104 (FIG. 3) of the sill body 24 to help prevent accidental slippage when the threshold is wet.

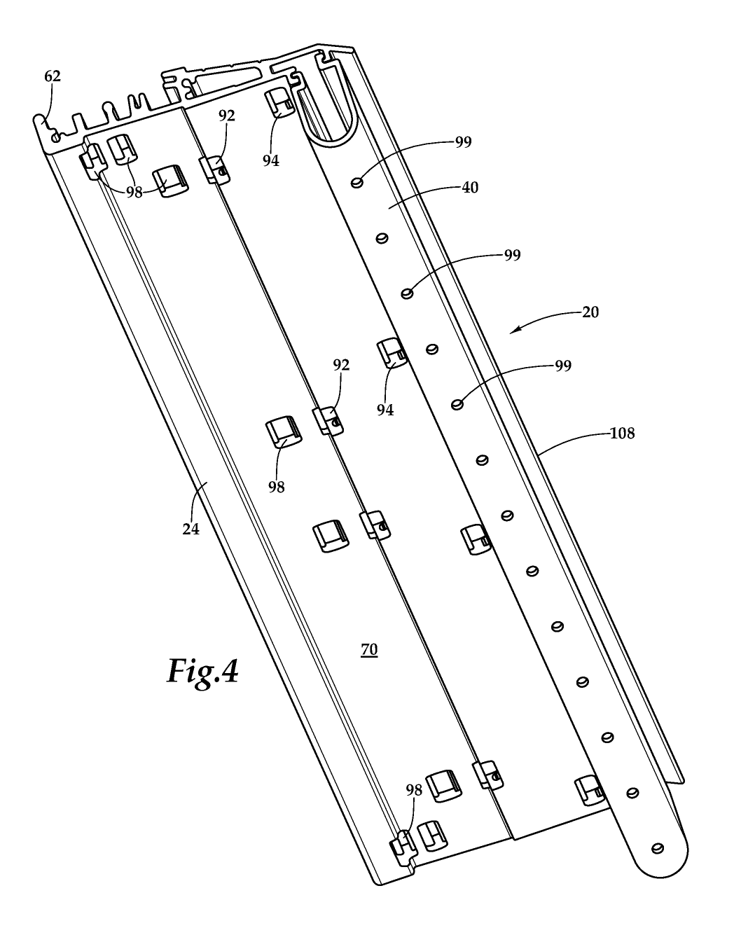

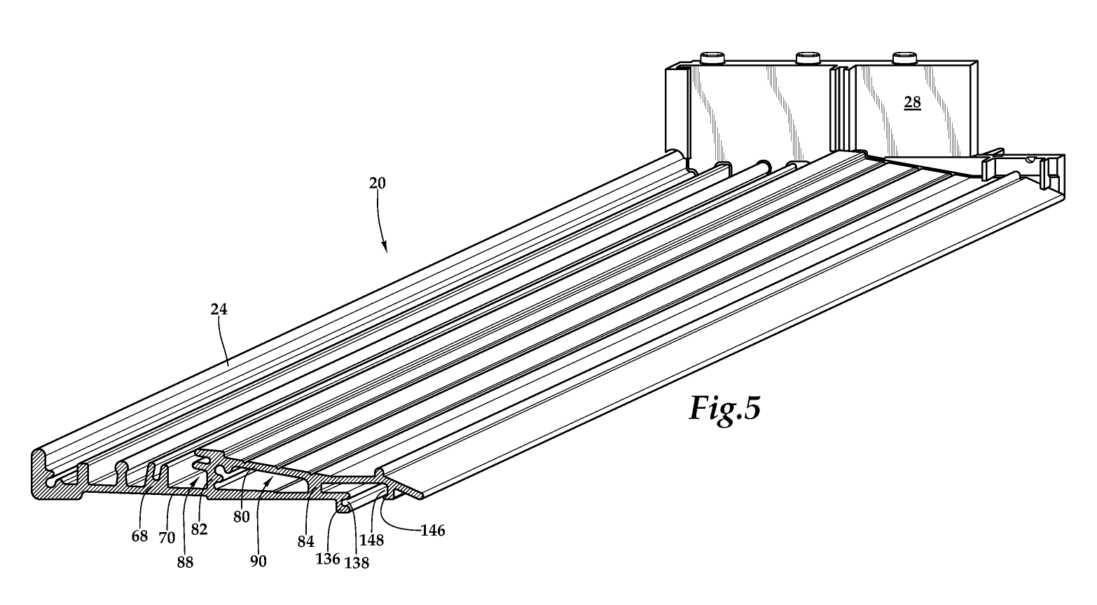

FIG. 3 is an enlarged cut-away isometric section view of sill assembly 20 of FIG. 2 with the right jamb 14 of frame 10 omitted for clarity. Sill body 24 is preferably formed of extruded aluminum or another metal or extruded plastic. Sill body 24 includes an upstanding inner wall 62 along an inner longitudinal marginal edge of sill body 24 and a door channel 64 formed between inner wall 62 and a longitudinal forward gutter wall 68 of sill body 24. One or more rails 72 located within door channel 64 and extending upwardly from a floor 70 of sill body 24 may include an elongate track 74 for guiding a sliding door (not shown) that slides within the door channel 64. Rails 72 and track 74 are preferably shorter than inner wall 62 so that the sliding door sits lower than inner wall 62 and slidably seals a bottom surface of the door against a resilient sealing strip 76 that is retained in a slot formed along a top edge of forward gutter wall 68. Sill body 24 includes a raised sill cap 80 located externally (outward) of door channel 64 and supported above floor 70 by first and second spaced apart longitudinally-extending upstanding walls, including a first wall 82 (best illustrated in FIG. 5) located outwardly of forward gutter wall and between forward gutter wall 68 and a second wall 84. A brush seal 86 or other weather sealing strip is attached to an inward edge of sill cap 80 and bears against an external face of door (not shown), maintaining the seal against the door face as it is slidably opened and closed. First wall 82 is spaced apart from forward gutter wall 68 to form a gutter or catchment tray 88 that catches any water that may drip between brush seal 86 and the door. The space above floor 70, below sill cap 80 and between first and second walls 82, 84 comprises a first chamber 90. One or more first passages 92 are formed through first wall 82 between catchment tray 88 and first chamber 90, allowing any water that may drip into catchment tray 88 to drain outwardly into first chamber 90. FIG. 4 is a bottom view of sill assembly 20 illustrating how first passages 92 are formed by milling or otherwise machining out a section of the floor 70 and a bottom section of the first wall 82 from below sill body 24. Similarly one or more second passages 94 may be formed in second wall 84 allowing water to drain from first chamber 90 into a reservoir chamber 96 (FIG. 3) formed between sill body 24 and drainage trough 40. Additional passages 98 are similarly formed in forward gutter wall and rails 72, 74 for drainage of any water that may be deposited inwardly, for example during opening and closing of the door. Floor 70 is formed with a slight decline in the outward direction relative to a supporting bottom surface of sill body 24 to thereby facilitate gravity drainage of water through passages 92, 94, 98. After passages 92, 94, 98 have been formed in sill body 94, the floor of the passages may be sealed by plugs, adhesive film or other sealing material (not shown). Thus, a collection of one or more passages extend from catchment tray 88 outwardly through sill body 24 toward exterior margin 44 to an outlet of the sill body, so that the passages (e.g., 92, 94, 98) allow water to drain from catchment tray 88 out of sill body through the outlet and, optionally, into the reservoir chamber 96 of drainage trough 40, when drainage trough 40 is attached to sill body 24. A series of weep holes 99 are drilled into or otherwise formed along the bottom surface of drainage trough 40 (generally after extrusion of drainage trough 40) for allowing water to slowly drain from reservoir chamber 96. Weep holes 99 are sized small enough that surface tension prevents water from draining when sufficient back-pressure is present. This allows a column of water to form within reservoir chamber 96 during storm conditions. The weight of the water column in reservoir chamber 96 then opposes ingress of water and air (wind) through weep holes 99 and, after sufficient water builds up, the column provides sufficient head to cause drainage through weep holes 99 even during high DP conditions, as is known in the art.

A threshold 100 of sill assembly 20 is formed in major part by a top surface 104 of sill cap 80, which is inclined and textured to provide a non-slip tread surface while allowing water to run off. An auxiliary tread bar 52 may be fastened to top surface 94 of sill cap 80 via screws which are screwed into second wall 84 from above. An upstanding guide rail 106 for a screen door (not shown) may extend along an exterior margin 108 of sill cap 80 and sill body 24.

Drainage trough 40 is detachably connected to sill body 24 outwardly from second wall 84 so that drainage trough 40 can be removed at the job site when the installation site (flooring, external decking, etc.) cannot accommodate the downwardly-extending drainage trough 40, or when high DP performance is not needed in the drainage system of sill assembly 20, or when another system is provided for high-DP drainage performance. Drainage trough 40 is detachably connected to an underside of sill body 24 adjacent an exterior margin of sill cap 108. Detachability of drainage trough 40 allows sill assembly 20 to be manufactured and sold with or without a drainage trough 40, and may enable frame 10 and sill assembly 20 to be converted in the field to a very low profile sill assembly, on demand, by removing the drainage trough 40 from the sill assembly when desired. FIG. 5 illustrates sill assembly 20 without drainage trough 40 attached. Thus, sill assemblies according to the present disclosure, such as sill assembly 20, may provide a low-profile handicap-accessible or wheelchair-accessible threshold (e.g. ADA-compliant threshold) with high-DP drainage features, while providing for the ability to convert in the field for installation in places that do not have space for the downwardly-depending drainage trough 40 (or where such a tough and reservoir are not needed or desired). In one embodiment, sill assembly 20 provides high-DP performance, such as at least DP-35 or DP-50 or better, while the threshold of sill assembly rises to a height of no more than 0.75 inch, or not more than 1.0 inch (2.54 cm), above the surface of the supporting flooring or subfloor of the entryway and the underside of the sill body 24.

With reference to FIGS. 3 and 5-7, drainage trough 40 is formed separately from sill body 24 and is generally U-shaped or channel-shaped with spaced-apart upstanding inner and outer walls 122 and 124. In other embodiments, other shapes, such as a V-shape or rectangular shape, may be employed. A first outwardly projecting lip 132 and first channel 134 are formed along an upper edge of inner wall 122 and extend along the entire length of inner wall 122 of trough 40. Lip 132 and channel 134 are shaped to interlock and nest with a first protrusion 136 and first groove 138 formed along an outer margin of floor 70 of sill body 24. A second outwardly-projecting lip 142 and second channel 144 are formed along an upper edge of outer wall 124 extend along the entire length of outer wall 124 of trough 40. Second lip 142 and second channel 144 face away from first lip 132 and first channel 134, and interlock with and nest in a second protrusion 146 and second grove 148 formed along an underside of sill cap 80 proximal of exterior margin 108 thereof. Second protrusion 146 and second groove 148 generally face toward first protrusion 136 and first groove 148. Outward spring force generated by the resilient material of drainage trough 40 (preferably extruded aluminum or plastic) causes lips 132, 142 to firmly seat in the respective grooves 138, 148 for retaining drainage trough 40 on sill body 24.

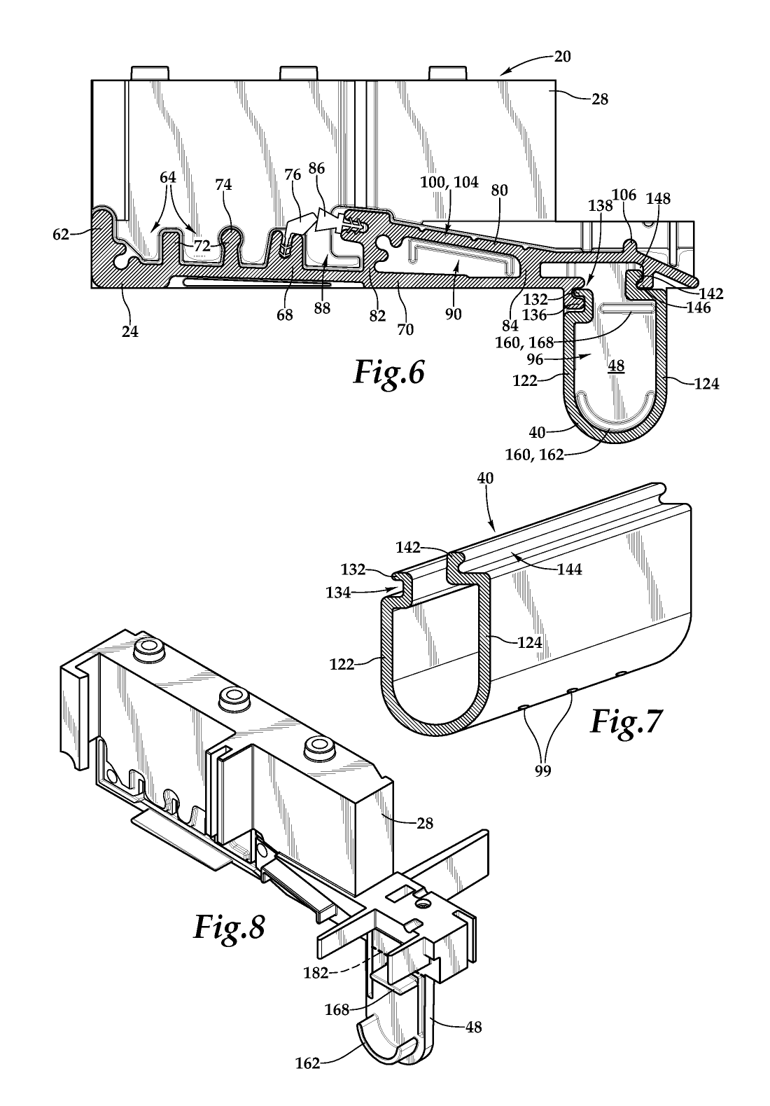

As illustrated in FIG. 6, when corner keys 26 (FIGS. 1) and 28 are installed, tabs or ridges 160 projecting from corner keys 26, 28 extend inwardly of the ends of the walls 122, 124 of drainage trough 40 and provide support for walls 122, 124. In particular, an arc-shaped lower ridge 162 (best shown in FIG. 8) projects from end cap 48 and lines and supports the end of a curved bottom wall portion 164 of drainage trough 40. A second ridge 168 (best shown in FIG. 8) projects from end cap 48 in a cantilever manner and extends from outer wall 124 of trough 40 toward inner wall 122 of trough 40 to impede movement of walls 122, 124 out of engagement with sill body 24 and thereby prevent trough 40 from inadvertently being dislodged from sill body 24.

With reference to FIG. 8, when drainage trough 40 is to be removed for conversion of the sill assembly 20, end cap 48 of corner key 28 may be detached, cut away, or otherwise severed from the remainder of corner key 28 along a score line or cutting zone represented by dashed line 182. In some embodiments, the end caps 46, 48 must first be removed in order to detach drainage trough 40 from sill body 24. In other embodiments, end caps 46, 48 are removed simultaneously with drainage trough 40 in a break-away operation. In still other embodiments, end caps 46, 48 are broken off, severed, cut away, or otherwise removed after drainage trough 40 is detached from sill body 24.

Various other means and methods of removably or detachably attaching drainage trough 40 to sill body 24 are envisioned within the scope of the present disclosure. For example, in one alternative embodiment (not shown), drainage trough 40 may be co-extruded with sill body 24, being connected thereto by a very thin wall section, such that drainage trough can be easily cut or torn away from sill body 24 to convert sill assembly 20 to a low profile sill. In still another embodiment, the drainage trough may be connected to sill body 24 by a snap-fit arrangement, adhesive, threaded fasteners or pinch connection.

It will be obvious to those having skill in the art that many changes may be made to the details of the above-described embodiments without departing from the underlying principles of the invention. The scope of the present invention should, therefore, be determined only by the claims.

1. A sill assembly for a door or window frame, comprising:
an elongate sill body defining a catchment tray and one or more passages extending from the catchment tray outwardly through the sill body toward an exterior margin of the sill body to an outlet, the passages allowing water to drain from the catchment tray and out of the sill body through the outlet; and
an elongate drainage trough detachably mounted to an underside of the sill body adjacent the exterior margin of the sill body, the drainage trough depending downwardly from the exterior margin to define a reservoir that is positioned to receive the water draining from the outlet of the passages, the drainage trough having one or more weep holes that allow the water accumulating within the reservoir to drain from the drainage trough, the drainage trough being detachably connected to the sill body so that the outlet of the passages is exposed when the drainage trough is not attached.

2. A sill assembly according to claim 1, wherein the weep holes are located along a bottom portion of the drainage trough and sized to cause the water to accumulate within the reservoir above the weep holes to form a column of the water that resists ingress of air through the weep holes and the sill assembly.

3. A sill assembly according to claim 1, wherein:
the drainage trough includes upstanding inner and outer walls, each of the inner and outer walls having a lip protruding therefrom; and
the sill body includes first and second grooves formed along inside and outside edges of the outlet of the passages, the inside and outside lips sized to interlock with the respective first and second grooves so as to retain the drainage trough to the sill body.

4. A sill assembly according to claim 3, wherein the drainage trough is formed of a resilient material so the inner and outer walls of the drainage trough provide outward spring force that biases the inside and outside lips into the respective first and second grooves.

5. A sill assembly according to claim 1, wherein a height of an upper threshold surface of the sill is less than 1.0 inch (2.54 cm) above the underside of the sill body.

6. A sill assembly according to claim 1, wherein the sill body includes a floor portion and a sill cap located outwardly of the catchment tray, the sill cap supported above the floor portion by spaced-apart first and second upstanding longitudinally-extending internal walls that define a chamber within the sill body above the floor portion and below the sill cap, between the first and second walls.

7. A sill assembly according to claim 6, wherein a first passage is formed through the first wall between the catchment tray and the chamber, and a second passage is formed through the second wall.

8. A sill assembly according to claim 1, wherein the detachable drainage trough is formed separately from the sill body.

9. A sill assembly according to claim 1, wherein the drainage trough is formed of extruded aluminum.

10. A sill assembly according to claim 1, further comprising left and right corner keys attached to ends of the sill body.

11. A sill assembly according to claim 10, wherein the left and right corner keys include end cap portions fitted against left and right ends of the drainage trough.

12. A sill assembly according to claim 1, further comprising a track formed in the sill body for guiding a sliding door or window.

13. A frame for a sliding door or window including the sill assembly of claim 1, and further including left and right jambs and a head jamb.
